(19) United States
(12) Patent Application Publication
(10) Pub. No.: US 2004/0117250 A1
(43) Pub. Date: Jun. 17, 2004

(54) Method and system for providing coupon savings using existing credit card processing infrastructure, and barcoded coupon having 2-D component

(76) Inventors: Allen Lubow, Brooklyn, NY (US); Cary Bunin, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/320,995

(22) Filed: Dec. 17, 2002

(51) Int. Cl. G06F 17/60

(52) U.S. Cl. 705/14

(57) ABSTRACT

Coupons (105) are encoded with an account identifier such as a credit or debit card number of the coupon issuer. The coupon may be a bar-coded coupon, or a coupon card, such as a magnetic stripe card or smart card. The bar-coded coupon may use a compact two-dimensional symbology such as Reduced Space Symbology (RSS) to carry the account identifier and other information such as enhanced consumer demographic data. Coupon information including the account identifier, a product or service identifier, and a discount identifier, are obtained from the coupon (105) at a point of sale location (100). The consumer is credited for the discount. The coupon information, including a merchant identifier are communicated to a processing center (135) using an existing credit card terminal (115) and communication protocol, such as ANSI X9, and processed like a conventional credit or debit card transaction.

### BACKGROUND OF THE INVENTION

The present invention relates generally to a new type of coupon, and to a method and system for processing the coupon.

Coupons are ubiquitous. Printed coupons appear in printed publications such as magazines and newspapers, direct mail flyers, in-store advertisements, and the like. Additionally, a recent phenomenon has been the use of web sites that allows consumers to print out coupons using their own computers and printers.

Coupons commonly use bar codes to carry information regarding the discount offered, the manufacturer and the product. The addition of bar codes has made coupons very popular with retailers, consumers and manufacturers since they facilitate the redemption process. In particular, coupons currently use a standardized bar code format such as the Universal Product Code (UPC) coupon codes to carry information that is necessary to process the coupon. Coupons that are coded with a UPC can be scanned in by a bar code reader at a point of sale (POS) location. The UPC coupon code is an all-numeric code. The first digit is a number system character of “5” that informs the POS system that it is scanning a coupon. Next, a five-digit company number identifies the manufacturer of the couponed item. Next, a three-digit family code generally identifies the type of the product. Next, a two-digit value code identifies the discount amount, e.g., the redemption value of the coupon. The last digit is a check character that is calculated from the previous eleven digits.

Additionally, since 1997, the UCC/EAN-128 Coupon Extended Code has been used. In addition to the primary UPC coupon code, an additional bar code symbol encodes other important information. The code includes first a Number System Character (NSC). Since two companies might have the same manufacturers number, one with a NSC of 0 and the other with an NSC of 7, the NSC of the manufacturer is automatically included in the extended code. Next, a five-digit Offer Code that is issued by the manufacturer is provided. Finally, a four-digit Expiration Date of Offer code is provided in the format: Month/Year (i.e., 07/99). The Uniform Code Council (UCC)-provides five variations in coupon format.

Conventionally, the coupons are handled by a merchant at the POS by scanning in the bar codes. Typically, the merchant visually checks that the consumer has purchased the eligible product, and the coupons are collected and periodically mailed to an outside processing facility, where they are manually processed. The merchant must wait a significant amount of time, such as a month or more, to obtain reimbursement.

### SUMMARY OF THE INVENTION

The invention provides coupon formats with enhanced information-carrying capabilities and reduced size, e.g., compare to the existing UCC/EAN-128 format which is enormous and occupies a large portion of the area of a printed coupon, along with automated processing techniques that can employ the existing communications and POS infrastructure. The invention further provides methods and systems that enable small businesses, individuals and other entities to issue coupons, that enable extensive amounts of demographic and individual consumer information regarding coupon use to be gathered, and that ensure coupons are redeemed only when the associated product has been purchased.

In one aspect, coupon savings are provided using the existing credit and debit card processing infrastructure at point of sale locations and credit and debit card processing centers. The invention also provides a bar-coded coupon having 2-D component that can carry additional data relative to conventional bar-coded coupons. The coupon is particularly suited for use in carrying a credit or debit card number.

By enabling additional data to be carried by a coupon, and by tailoring the coupon format to match the existing formats of data required in credit and debit card transactions, the coupon becomes, in a sense, the manufacturer's or other coupon issuer's credit card on loan to the consumer. Processing of the coupon is achieved in the same way as the processing of a conventional credit or debit card, but the consumer receives the coupon savings at the point of sale, and the coupon issuer is charged for the discount amount. The merchant may be reimbursed for the discount using an electronic funds transfer (EFT) or other arrangement. Accordingly, processing speed of coupons is greatly increased, and new marketing opportunities are created.

In one aspect of the invention, a bar-coded coupon suitable for redemption at a point of sale location includes a bar code symbol carrying} an account identifier of an issuer of the coupon, a product or service identifier, and an identifier of a discount amount to be credited to a consumer upon purchase of the product or service, and to be charged to the issuer in accordance with the account identifier. In another aspect, a bar-coded coupon suitable for redemption at a point of sale location includes a bar code symbol carrying an identifier of an account of an issuer of the coupon, an identifier of a consumer's account, and an identifier of an award amount to be awarded to the consumer's account and to be charged to the issuer's account. Analogous coupon cards such as magnetic strip cards and smart cards may be used which carry the same data. Analogous methods for processing a bar-coded coupon, magnetic stripe card or smart card at a point of sale location are also provided.

In a further aspect, a method for processing coupon transaction information received from a merchant at a point of sale location includes recovering, from the coupon information, an account identifier of an issuer of the coupon, an identifier of a discount amount that has been credited to a consumer upon purchase of a product or service from the merchant, and an account identifier of the merchant. A charge is provided against the account of the issuer according to the identifier of the discount amount and the account identifier of the issuer, and a payment is provided on behalf of the merchant according to the identifier of the discount amount and the account identifier of the merchant.

In a further aspect, a method for processing coupon transaction information received from a merchant at a point of sale location includes recovering, from the coupon transaction information, an account identifier of an issuer of the coupon, an identifier of an award amount to be awarded to a consumer, and an account identifier of the consumer. A charge is provided against the account of the issuer in accordance with the award amount identifier, and an award is provided on behalf of the consumer in accordance with the award amount identifier and the account identifier of the consumer.

In a further aspect, a method for authorizing redemption of a bar-coded coupon at a point of sale location includes (a) scanning the coupon to obtain at least one product identifier therefrom, (b) scanning at least one product purchased by a consumer at the point of sale location to obtain at least one product identifier therefrom, and (c) comparing the product identifiers obtained in step (a) to the product identifiers obtained in step (b) to determine whether there is a mismatch. If there is no mismatch, redemption of the coupon is authorized. If there is a mismatch, redemption is not authorized.

Related computer program products are also provided.

### BRIEF DESCRIPTION OF THE DRAWINGS

FIG. 1 illustrates a coupon processing system;

FIG. 2 illustrates a coupon processing method;

FIG. 3(a) illustrates a conventional UCC/EAN-128 coupon format;

FIG. 3(b) illustrates a first embodiment of a two-dimensional bar code combined with a UCC/EAN-128 bar code;,

FIG. 3(c) illustrates a second embodiment of a two-dimensional bar code combined with a UCC/EAN-128 bar code;

FIG. 4(a) illustrates a two-dimensional bar code combined with a Code 128 bar code;

FIG. 4(b) illustrates a two-dimensional bar code combined with a UPC (A) bar code;

FIG. 4(c) illustrates a two-dimensional bar code combined with a stacked bar code;

FIGS. 5(a)-(g) illustrate examples of optimized coupon bar codes; and

FIG. 6 illustrates a method for ensuring that coupons are redeemed only when the associated product has been purchased.

### DETAILED DESCRIPTION OF PREFERRED EMBODIMENTS

In accordance with the invention, by changing the symbology used on coupons from the UCC/EAN-128 code to Reduced Space Symbology (RSS) or other compact and/or two-dimensional symbology, coupons with greatly enhanced functionality can be made due to the enormous additional information that can be contained in the bar code symbols. Further, by emulating the format of a credit card transaction, coupons employing bar codes, magnetic stripes and smart cards can be processed as credit card transactions using the existing or legacy credit card processing infrastructure. This affords the benefits of speedy processing of the monies involved as well as conveying additional data associated with the coupons, thereby opening up tremendous new marketing opportunities. The tedium of collecting coupons for redemption by a redemption center is also avoided. Moreover, the invention can be phased in conveniently by providing bar-coded coupons with both one-dimensional and two-dimensional symbols.

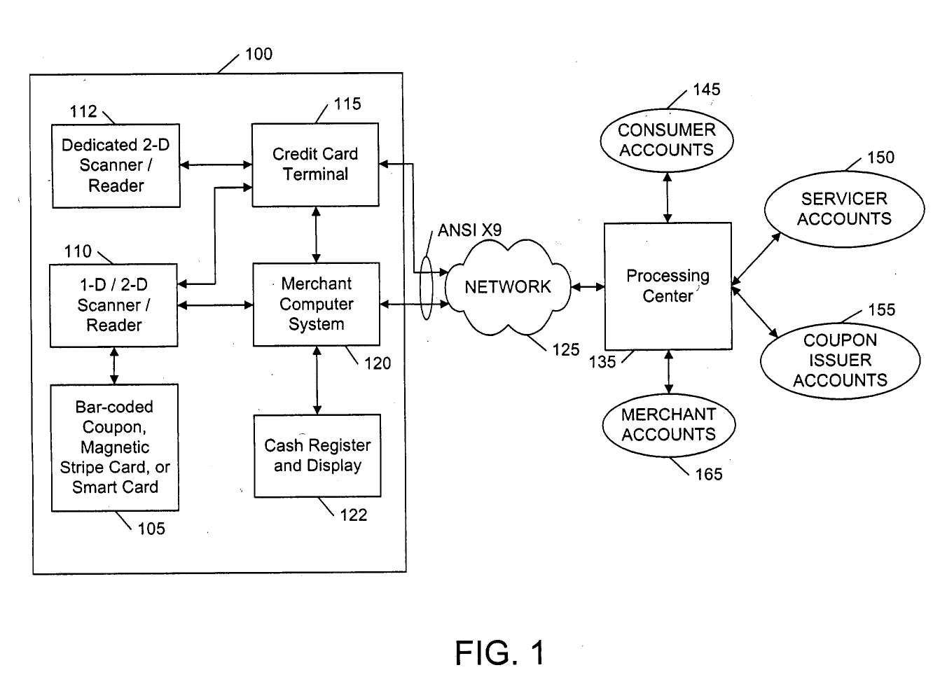

FIG. 1 illustrates a coupon processing system. A point of sale (POS) location 100 may be a retail store, self-serve kiosk, virtual location, a consumer's home, or other business location where a merchant sells products or services. The term “merchant” is meant to encompass essentially any business that provides a product or service, including businesses serving the public, the government, business-to-business, and so forth. The terms “sell”, “purchase” and the like are meant to encompass sales in the conventional sense as well as rental of products and other arrangements. A scanner/reader 110 scans a bar-coded coupon 105, or reads a magnetic stripe card or smart card, e.g., a coupon card, any of which is encoded with data according to the invention. The scanner/reader 110 is provided with software for reading the information and communicating it to a merchant computer system 120 or a credit card terminal 115. A magnetic strip card may be read using a known swipe reader while a smart card may be read using a known smart card reader. Thus, in addition to bar-coded coupons comprising a bar code symbol printed on a substrate such as paper, the invention may be used with other data storage media such as magnetic stripe cards and smart cards that store the equivalent data. Many modern POS locations already have scanners that can read both one-dimensional and two-dimensional bar codes. An example of an RSS-enabled scanner is the Cyclone made by Symbol Technologies, Inc. If the scanner 110 can only read 1-D bar codes but not 2-D bar codes, e.g., the scanner 110 is not RSS-compatible, the conventional bar code portion of the coupon can be read. Or, a separate, dedicated 2-D scanner 112 that is RSS-compatible may be provided. The scanner/reader 112 may be a standalone RSS coupon terminal that works in conjunction with the credit card terminal 115. It requires power and a telephone line, which may be shared with other terminals/scanners. The scanner/reader 112 may use a second handheld scanner that is placed at the checkout counter for scanning RSS coupons only. Thus, when the scanner/reader 110 is not RSS compatible, the separate dedicated scanner/reader 112 may be used to scan or read the coupon. If the scanner/reader 110 is RSS compatible, the separate dedicated scanner/reader 112 is not needed. Moreover, the coupons may have graphics and supporting text that inform the cashier and consumer that they require processing by a 2-D scanner.

Scanning equipment for 2-D bar codes is becoming affordable enough for even small businesses. In fact, the benefits derived from the invention will encourage businesses that previously did not have a need for scanners to obtain one. This includes service industry businesses, e.g., hair salons, travel agencies, entertainment facilities, and the like, that mainly provide services to consumers rather than products. The cashier and consumer need no special training since the coupons provided according to the invention are handled and scanned in the same way as convention coupons. Moreover, since all processing occurs electronically, the coupons can be discarded after they are scanned. Discarded coupons are destroyed, e.g., by shredding, to prevent misuse. A shredder may be built into the scanner/reader 110 or 112 for this purpose.

The scanners/readers 110 or 112 communicate with a credit card terminal 115, which may have a swipe reader and a keypad. An RS232 port on the credit card terminal 115 may be used to receive data from the scanners/readers 110 or 112. Such ports are made available for interfacing with peripheral devices such as keyboards. The credit card terminal 115 may be of the type that is ubiquitous in businesses that accept credit cards and debit cards as payment for their products or services. VeriFone, Inc. is one major supplier. Generally, the coupon information can be conveyed to the credit card terminal 115 via a variety of means, such as manually typing in the information, reading the bar code and transmitting the data to the unit as ASCII text, or magnetic stripe or smart card reading if the coupon offer was so designed. The scanner 110 may communicate with a merchant computer system 120, if available, e.g., via an RS232 link. The merchant computer system 120 may store information regarding products purchased, sales figures and the like, for inventory control and other purposes. The merchant computer system 120 may also store coupon information from the scanner 110. A cash register and display 122 may communicate with the merchant computer system 120 as known in the art to inform the consumer of the price of each purchased item.

According to the invention, the information that is obtained by the scanner/reader 110 or 112 may include an account identifier, such as a credit card or debit card number, of the coupon issuer, which is the entity that is applying for the discount provided by the coupon. As explained further below, the use of such an account identifier allows a coupon to be electronically processed using the existing credit and debit card processing infrastructure, including the existing scanner/reader 110, credit card terminal 115 and the upstream processing facilities and protocols already in place. Other coupon transaction information, such as the product and discount, are piggybacked onto the account identifier and likewise communicated from the credit card terminal to the upstream facilities. The coupon discount may be provided as a fixed amount or as a percentage of the regular price of an item. In one approach, the credit card terminal 115 processes the coupon information from the scanner/readers 110 or 112. In another approach, the coupon information is processed by the merchant computer system 120, which has an analogous functionality as the credit card terminal 115. In either case, the coupon transaction information for different transactions may be stored in the credit card terminal 115 or merchant computer system 120. Periodically, such as daily, the coupon transaction information is uploaded to a processing center 135 as a batch job via a communication network 125 such as a telephone network. Importantly, the coupon transaction information is communicated using the existing protocols for credit and debit card purchases. There are several related standards or protocols that describe a credit or debit card transaction. The basic standard is ANSI X9.1-1991, entitled Bank Cards Magnetic Strip Data Content for Track 3, incorporated herein by reference. IN accordance with the invention, the data read in from the coupon bar code may emulate the track 3 data. However, many variations are possible, and the invention can be used with any credit or debit card processing scheme. The batching and processing of coupon data may be performed according to a schedule of services provided by the processing center 135.

The ANSI X9 standard provides for the communication of transaction information such as credit or debit card number, card/payment type, expiration date, whether card and consumer are present, transaction amount, merchant identifier, security/authorization code that is manually entered by the cashier, such as a customer zip code, transaction date and time, and other information. As used with the present invention, this information may be referred to as “coupon transaction information.” In conventional transactions where a consumer pays for an item using a credit card, up to 105 characters of ANSI information appear on the consumer's credit card statements for a transaction to provide the consumer with a record of the transaction. However, with the present invention, the account identifier is associated with the coupon issuer, and the coupon information, including the discount amount, product identifier, consumer data and other information, may be carried in the 105 characters.

In particular, a subset of ANSI X9 is the ANSI X9.59 Payment Card Process, which may include the following data element. This typical of what is expected in a credit card transaction. This standard is applicable as well to debit cards. A payment card refers to a credit card or debit card.

X9.59 signed payment elements:

| | |
|---|---|
| StandardVersion | X9.59 protocol version |
| Paycode | payment instructions to merchant |
| PrcC | customer account number (becomes the coupon issuer |
| | account number) |
| LUID | (customer) locally unique identifier |
| PrcM | merchant account number/id |
| PaydataC | currency type and transaction amount |
| DateS | transaction date/time |
| DateE | account expiration |
| SHS{OD} | hash of order detail |
| DSS{VD} | digital signature of X9.59 signed elements |

The X9.59 addenda field:

| | |
|---|---|
| StandardVersion | X9.59 protocol version |
| Paycode | payment instructions to merchant |
| LUID | (customer) locally unique identifier |
| DateS | transaction date/time |
| SHS{OD} | hash of order detail |
| DSS{VD} | digital signature of X9.59 signed elements |

However, many variations are possible, and the invention is meant to encompass any credit card processing scheme.

The invention is meant to be suitable for use with any type of account identifier that can be processed to obtain a payment from a coupon issuer. This includes account numbers of credit cards, including universal credit cards, affinity cards, bank cards issued by banks, such as Visa, MasterCard and Discover Card, travel and entertainment cards, such as American Express, Diners Club and Carte Blanche, house cards that are good only in a particular business or chain of businesses, such as a department store or gas station chain, or phone companies, as well as debit cards, which can be processed the same as credit cards using the ANSI X9 standard. Most national credit cards and debit cards have a numbering system that follows the ANSI Standard X4.13-1983 standard, while house cards, gas cards, and phone cards often follow their own system. The phrases “credit card number” and “debit card number” and the like are meant to encompass any credit card or debit card identifier, respectively, whether it includes a string of numerals, letters, other symbols, or any combination thereof.

Under, ANSI Standard X4.13, the credit or debit card has a 15-digit account number and one check digit. The first digit in the credit-card number signifies the system, e.g., 3 for travel/entertainment cards, 4 for Visa, 5 for MasterCard, and 6 for Discover Card. The structure of the card number varies by system. For example, American Express card numbers start with 37; Carte Blanche and Diners Club with 38. For American Express—Digits three and four are type and currency, digits five through 11 are the account number, digits 12 through 14 are the card number within the account and digit 15 is a check digit. for Visa—Digits two through six are the bank number, digits seven through 12 or seven through 15 are the account number and digit 13 or 16 is a check digit. For MasterCard—Digits two and three, two through four, two through five or two through six are the bank number (depending on whether digit two is a 1, 2, 3 or other). The digits after the bank number up through digit 15 are the account number, and digit 16 is a check digit.

Optionally, the coupon transaction information may be processed immediately after each transaction. A further option is for the credit card terminal 115 to obtain an authorization code for each transaction from the processing center 135. The authorization code assures that the credit account is in good standing and that there is a sufficient balance, available. It is the same authorization code that is received for conventional credit card purchases, and may be obtained in specified situations. For example, an authorization code may be obtained when the coupon discount exceeds a certain dollar amount. This can be achieved, e.g., using software that checks the discount amount to see if it exceeds a given amount. The code is stored by the credit card terminal 115 and periodically uploaded to the processing center 135 as discussed above. The merchant may wish to obtain authorization codes depending on its agreement with the provider of the credit card terminal 115. For example, the merchant may be charged a lower monthly fee for using the terminal if it agrees to obtain authorization codes for transactions since fewer unauthorized or fraudulent transactions will occur. On the other hand, a delay may be incurred during the checkout process while waiting for the code.

The processing center 135, which may be associated with a bank, for instance, processes the coupon transaction information received from the POS 100 as if it was a conventional consumer credit or debit card purchase. However, in accordance with the invention, since the account identifier in the coupon transaction information is associated with the coupon issuer, and not the consumer, the coupon issuer's account 155 is charged for the discount amount of the coupon. A service charge may also be assessed by the processing center 135 or other involved entities and maintained at servicer accounts 150. This fee may be analogous to the processing fee assessed in conventional credit or debit card transactions, e.g., a fixed fee or percentage. The discount amount that is included in the coupon transaction information is then credited to the account 165 of the merchant who accepted the coupon. The merchant may be identified by the merchant identifier that is communicated to the processing center 135 with the coupon transaction information using the existing protocols. A database at the processing center 135 may associate the merchant identifier with a merchant account number for an electronic funds transfer (EFT). Or, the merchant account number itself may be carried in the coupon transaction information in which case no database lookup is required to route the reimbursement. It is also possible for a credit to be given to the consumer's account, as discussed further below. Advantageously, the merchant can be reimbursed very quickly, e.g., in matter of one or two business days. Also, due to the short float time afforded by the invention, merchants will be willing to accept higher value coupons, e.g., $5.00, $10.00, $50.00 or more. Thus, manufacturers and others that would previously engage in a rebate by mail program to provide consumers with large discounts on higher-cost items such as appliances can now simply provide coupons with the desired discount. Consumers will be more responsive to such offers since they receive the discount at the time of purchase rather than having to wait several weeks for a rebate by mail. These rebates could be called “coupon rebates.” The invention thus enables a paradigm shift in how coupons are approached by moving them from an arena in which they provide modest savings of, e.g., a dollar or less previously, to an arena in which purchases of thousands of dollars are routinely handled. Moreover, higher-value coupons discounts are afforded the same protections of the existing credit and debit card processing infrastructure.

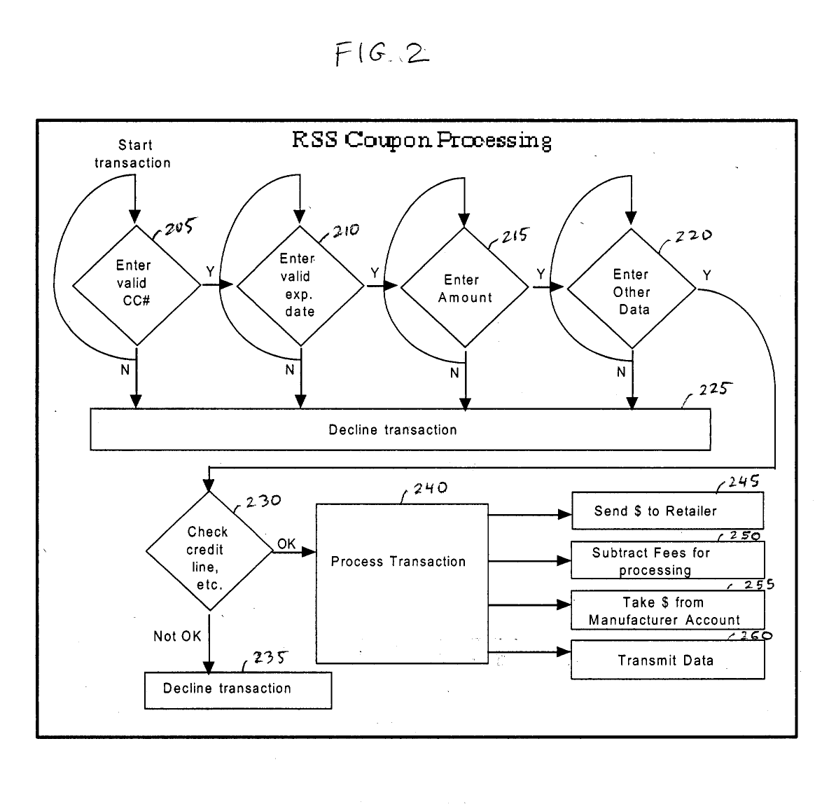

FIG. 2 illustrates a coupon processing method. Steps 205 through 225 may occur at the POS location 100, while steps 230 through 260 may occur at the processing center 135. At block 205, the credit card number is read and entered from the coupon 105. If the information received does not appear to be a valid credit card, e.g., based on the number of digits or other criteria, the transaction is declined (block 225). At block 210, the expiration date of the coupon is examined to determine whether the coupon has expired. If so, the transaction is declined. At block 215, the amount of the discount is obtained. If the amount cannot be read, or appears to be inconsistent with the product or other criteria, the transaction is declined. At block 220, other data that is encoded in the coupon is obtained. This data includes the new information that can be encoded using the techniques of the present invention, such as information relating the distribution and redemption of the coupons, and information relating to the consumers who redeem them, including general demographic data, and specific data associated with the individual, if available.

If the above steps are completed successfully, the coupon transaction information is processed further. At block 230, the issuer's credit or debit account may be checked to see if it is in good standing and whether there is a sufficient credit line. This may involve obtaining an authorization code as discussed above. Generally, reputable coupon issuers such as large manufacturers may be extended credit by the processing facility, which reimburses the merchants before obtaining payment from the manufacturer. In other cases, the processing facility may require that the issuer provide a cash deposit before the merchants are paid. An account for paying for the coupon discounts may have funds transferred to it by the issuer based on credit card protocols. The account may have a minimum balance and replenishment rate attached to it. If a problem is detected in this regard, the transaction is declined (block 235). Assuming no such problems are detected, at block 240, the transaction is processed, the result of which may include sending funds to the retailer or other merchant (block 245), subtracting fees for processing (block 250), and taking funds from the manufacturer's, e.g., coupon issuer's, account (block 255). Since the coupons are processed like credit card transactions, the money is taken from the issuer's account and transferred to the merchant's account in accordance with the offer codes provided in the coupon transaction information and the particular details of the transaction handling as established between the issuer and processing unit. At block 260, the additional data regarding demographics and the like, can be communicated to a facility for further analysis and marketing research. Reports developed from the coupon transaction information can be amassed and periodically presented to the coupon issuer. The coupon issuer might select from monthly, weekly, daily or other time intervals to receive informational reports and schedule reimbursement payments to the merchants.

In particular, the coupon issuer or other entity may employ software to process the wealth of new coupon information that is available. By coordinating the coupon formats, the advertisers and retailers can devise methods to provide highly-targeted marketing, and marketing for gathering consumer purchasing habits, consumer demographics, and the like. For example, the coupon information may include information relating to the distribution and redemption of the coupons, and the particular consumers who redeemed them. The distribution information may include the geographical location in which the coupon was distributed, the specific distribution media, e.g., name of a newspaper or magazine, even the specific edition of a newspaper, e.g., morning afternoon or evening, and the date of issuance of the media. Moreover, coupons that are provided to specific consumers, e.g., in a direct mailing, can be individually encoded with the consumers' identities or demographic information regarding age, education, income, family status, previous purchasing habits, and so forth.

Coupons that consumers print from a web site, e.g., web-based coupons, can also include specific information relating to the consumer that is obtained from the consumer's interaction with the web site. An Internet web site that allows the consumer to select from a variety of coupons and print them out for redemption can be uniquely identified and serialized to prevent duplicate use. The consumers receive data from the web site for use in printing coupons using their own computers and printers. Such coupons may appear the same as coupons printed in other media, e.g., having a bar code, picture of the product, merchant information about redemption, restrictions, the offer code, the discount amount and expiration date. The coupon is presented at the store and processed the same as a coupon that was printed by the coupon issuer. The unique encoding method and serialized number insure that the coupon is not used twice or duplicated. The consumer can be warned against duplicate use. The coupon can also have the consumer's name. The additional demographic information is conveyed to the manufacturer during coupon processing.

For instance, the consumer may be asked to respond to a survey to obtain a coupon for a discount on an item of interest. The coupon printed out by the consumer using data from the web site can include information obtained from the responses. Moreover, a consumer can be given a cash payment or award for interacting with the web site by receiving data for printing a coupon that designates the consumer is to receive a payment or award. In this case, the credit or debit card number or other account identifier, such as a bank account identifier, e.g., checking or savings account number, is encoded in the coupon along with the credit or debit card number of the coupon issuer, e.g., the sponsor of the survey. The consumer's responses to the survey can also be encoded in the coupon. Processing of the coupon is similar to the manner in which a consumer obtains a credit when returning an item that has been purchased with a credit or debit card. Alternatively, an electronic funds payment can be made to the consumer's checking or savings account. Or, the consumer may be awarded points, analogous to frequent flyer miles that can be redeemed for products or services. The term “award” or the like is meant to encompass any such payment or award to the consumer as discussed herein. The award may be given following the consumer's interaction with the web site with no further requirements.

For example, the manufacturer could set up a website where the customer is invited to participate with the added incentive of earning money. The customer fills in his or her own credit or debit card information with expiration date, account number and street address. For a survey, a website might state: “Take five minutes to answer the following ten questions and earn $1.00 from Proctor and Gamble.” The customer fills in the survey, then fills in a set of text fields which ask for the customer's credit or debit card, expiry date, and street address for security purposes. Then the customer prints the resulting coupon and brings it to a merchant to process. In another approach, the website states: “Enter a contest to win to $1,000,000 instantly from Proctor and Gamble.” The customer fills in the entry blank and a set of text fields as discussed, and the entry is submitted to the website server to determine if the customer is a winner. The customer can be notified right there on line and obtain data to print a coupon to claim the prize. Or, the consumer may bring the coupon to an authorized merchant to see if he or she has won a prize.

A further advantage of the coupons of the present invention is that the additional information that is carried allows the coupon issuer to be a different entity than the manufacturer of the product. This opens up many opportunities for cross-marketing and other new types of marketing and commerce. In contrast, a conventional coupon only carries the UCC company number, which identifies the manufacturer, and which must be the same as the code on the product to which the coupon applies. For example, a bar code according to the invention may have a conventional portion that identifies the manufacturer via the UCC company number, and an additional portion, such as a two-dimensional bar code portion, that identifies the account identifier of another party. To illustrate, a health club may issue a coupon that allows a consumer to obtain a discount on exercise equipment or health foods products, or a hotel may issue a coupon that allows a consumer to obtain a discount on a car rental, or an admission fee to a local attraction. In another example, an individual can print a coupon as a gift that allows the recipient to obtain a discount on a certain product or service.

Various bar code symbologies that may be used are discussed below. Generally, a bar code symbol according to the invention may look like one of the existing coupon linear formats, e.g., UPC A or UCC-EAN-128, but adds a two-dimensional symbol such as an RSS symbol. Depending on how the checkout counter at a POS location is designed, the scanner may be able to seek the additional information from either symbol. For example, if the scanner is designed to seek RSS two-dimensional additional data if it sees a UPC (A) code with a leading digit of ‘5’, indicating that it is a coupon, then the RSS two-dimensional data may be added to the UPC (A) code. If, on the other hand, the UCC/EAN-128 portion of the coupon has been properly formatted, the scanner may seek additional information if it encounters such a symbol. UCC/EAN-128 codes may be read as the linear portion of an RSS symbol if the symbol contains both the flag and linkage characters necessary to cause the scanner to understand it to be the linear portion of an RSS symbol. Fortunately, the scanner can read the UCC/EAN-128 code with or without the flag and linkage characters and may be designed to work both ways.

A further aspect of the invention involves a computer such as a personal computer that is programmed to create the bar code symbols disclosed herein, as well as a computer program product having software for enabling the computer to create such bar code symbols providing the functionality disclosed herein. Any known software development and computer programming techniques may be used for this purpose. Barcode Technology is one supplier of such software.

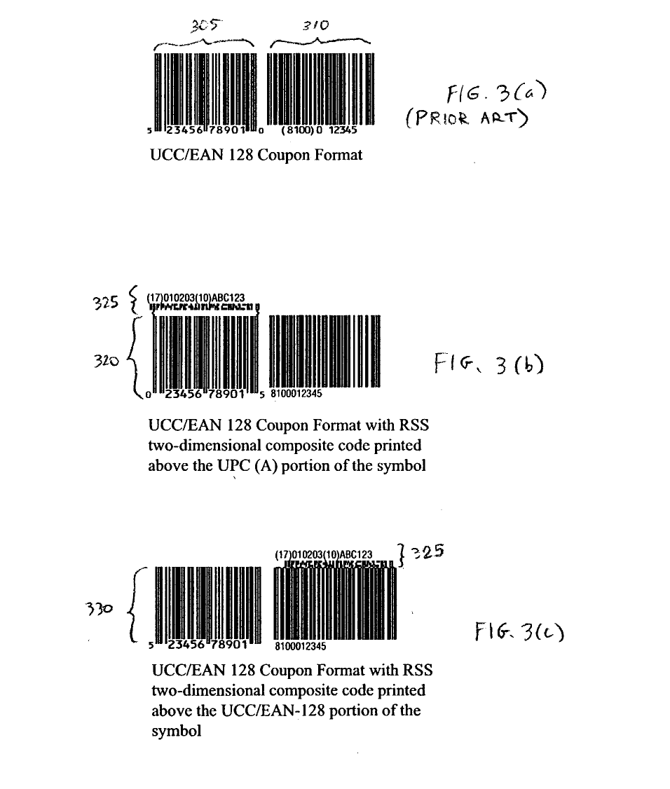

FIG. 3(a) illustrates a conventional UCC/EAN-128 coupon format. The symbol is linear or 1-D since it includes only vertical lines. The symbol includes two bar codes side by side, namely the UPC (A) Universal Product Code symbol 305 on the left, and the UCC-EAN-128 symbol 310 on the right. The two pieces of information can be scanned in a single operation by scanners designed for this purpose.

FIG. 3(b) illustrates a first embodiment of a two-dimensional bar code combined with a UCC/EAN-128 bar code. The symbol includes a UCC/EAN-128 coupon format 320 with an RSS two-dimensional composite code 325 printed above the UPC (A) portion of the symbol. By conforming to the standards of UCC/EAN 128 coupon formats, the additional RSS two-dimensional information allows both retailers equipped with the new RSS scanners and those without the new equipment to use the same coupons. Those with the new scanners that can read the RSS information will benefit by having the coupons processed in the new way discussed herein. Those without the new RSS scanners will continue to accept coupons as they have always done.

FIG. 3(c) illustrates a second embodiment of a two-dimensional bar code combined with a UCC/EAN 128 bar code. The symbol includes a USS/EAN 128 coupon format 330 with the RSS two-dimensional composite code 325 printed above the UCC/EAN-128 portion of the symbol.

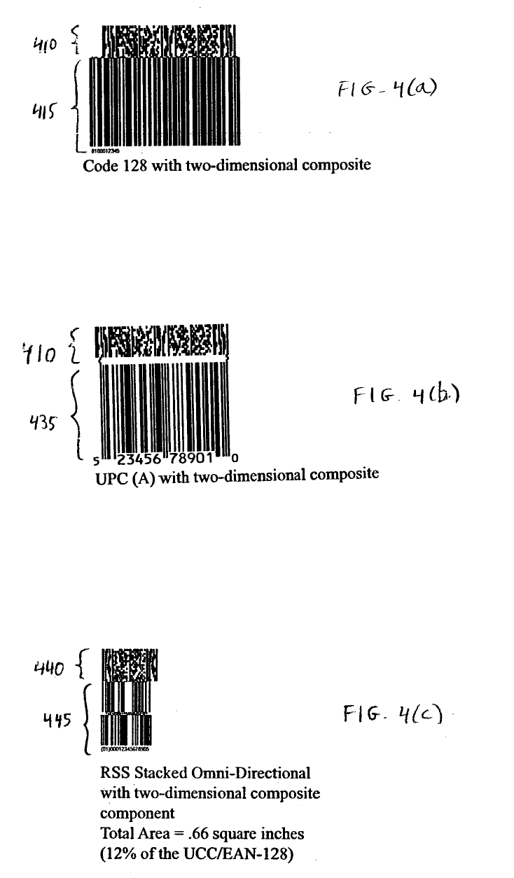

FIGS. 4(a)-(c) are examples of bar code symbols whose design is not constrained by a requirement to conform to the standards of UCC/EAN 128 coupon formats. They provide RSS Coupons that are totally redesigned to minimize the size of the bar code and reflect the type of informational exchange discussed herein with the additional RSS two-dimensional bar code.

FIG. 4(a) illustrates a two-dimensional bar code combined with a Code 128 bar code. The symbol includes a two-dimensional composite bar code 410 printed above a Code 128 bar code 415.

FIG. 4(b) illustrates a two-dimensional bar code combined with a UPC (A) bar code. The symbol includes the two-dimensional composite bar code 410 printed above a UPC (A) bar code 435.

FIG. 4(c) illustrates a two-dimensional bar code combined with a stacked bar code. The symbol includes a two-dimensional composite 440 above an RSS stacked omni-directional component 445.

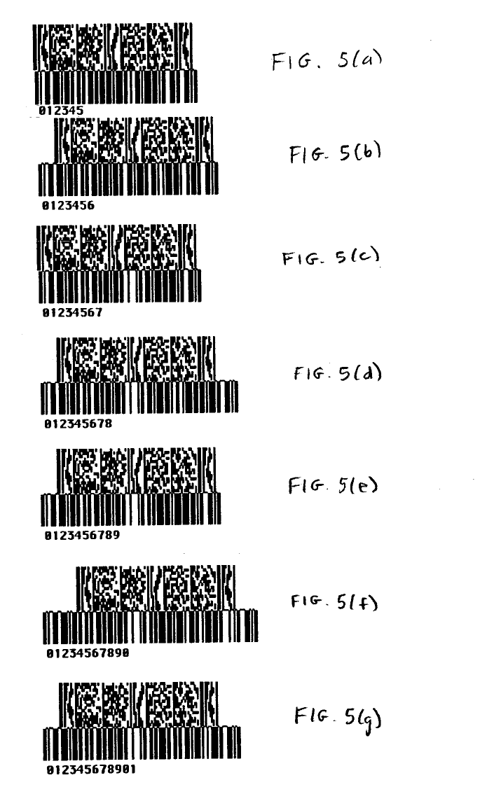

FIGS. 5(a)-(g) illustrate examples of optimized coupon bar codes. These are further examples of bar code symbols whose design is not constrained by a requirement to conform to the standards of UCC/EAN 128 coupon formats. They provide RSS coupons that are totally redesigned to minimize the size of the bar code and reflect the type of informational exchange discussed herein with the additional RSS two-dimensional bar code. The bar codes represent different sizes that may be used. The different configurations and types of RSS symbols allow them to be used in different ways. Each code includes a linear portion carrying a different number of characters, and consequently having a different width, while the 2-D portion in each example is the same. For example, the linear portions of FIGS. 5(a)-(g) carry six through twelve digits, respectively.

Since the coupons may use smaller bar code symbols, the overall coupon size can be decreased or more human-readable promotional information can be provided. For example, the total area of the format of FIG. 4(c) is 0.66 square inches, or 12% of the 5.25 square inch area of the UCC/EAN 128 coupon format of FIG. 3(a). RSS coupons also can carry an additional sixty characters of data. Advertising costs can be reduced since fewer pages are needed to provide the same coupon offers. Or, additional space in the coupon can be devoted to graphics and the like. Environmental benefits due to reduced paper use result as well.

The bar-coded coupon symbols disclosed herein also provide increased information beyond the amount of information that a typical UCC/EAN-128 coupon format holds, e.g. the offer number, serial number, expiration date, product identification, family code and value code. RSS variations allow 56, 338, or 2363 more characters of information beyond the fourteen characters of the UCC/EAN 128 coupon format. The 338-character format is believed to be suitable at present.

Standardized formats can be provided for the additional information that the coupons can contain. For example, the additional information beyond the standard UCC/EAN-128 Coupon Formats may include: the Global Trade Item or Identification Number (GTIN) with the Application Identifier (AI) of (01), the Date with AI (20), the Time, the Offer Code, the Offer Expiration Date, the Sub-Offer Code, the Issue Date, and a unique serial number. For example, offer code “12345” may be assigned to coupons for Brand X soap printed in the NY Times newspaper on Sunday Aug. 24, 2002 and distributed in the New York Metropolitan Region. The sub-offer code may identify whether the coupon appeared in the morning, afternoon or evening edition of the newspaper.

Another problem of existing coupon formats is the limited area devoted to family codes. A family code is designed by the manufacturer to indicate which set of products the coupons are targeted. However, due to the nature of various company product lines, this is not always sufficient to make distinctions between products. Accordingly, enhanced family code information can be, encoded using the additional data-carrying capacity of the coupons of the present invention.

The coupons may also be coded with the expiration date of the credit or debit card account and/or the expiration date of the individual coupon offer, the latter of which is used to establish the validity of the coupon for redemption during processing. Since a manufacturer can have more than one coupon offer running simultaneously, the expiration dates may vary from coupon to coupon. The RSS coupon may also contain specific information put into it by the manufacturer in preparation for a particular method of distribution. For example, if readers of a certain magazine or newspaper have a particular set of demographics, those demographic statistics can be inserted in the coupons that are printed in the magazine so that during redemption, that information is passed along to the manufacturer.

In addition to the above-mentioned information, the entire string of characters in the coupon can be encrypted and hold a CRC code and security code. The CRC code serves to check the data integrity and greatly reduce or eliminate duplicate and fraudulent coupons. Since the coupons can be printed with a greater degree of specificity, patterns of fraud and duplication can more easily be detected. Other safeguards can be provided to avoid fraudulent use of the credit and debit card numbers, such as reserving specified number sequences for credit and debit cards that are used for coupons, and applying associated transaction limits based on the discount offered. Moreover, the credit or debit card account of an issuer can have an expiration date associated with it according to the coupon's expiration date.

The information contained in the two-dimensional portion of the RSS coupon may be encoded to prevent others from being able to read and use that same information, and to prevent the processing center from being able to read the enclosed information, which is made available only to the coupon issuer.

Further, to reduce duplicates and fraud, mass printed coupons can more easily be differentiated by assigning unique offer codes and sub offer codes.

A further advantage of the present invention is that it allows small businesses, individuals and other entities to issue coupons. In comparison, under the conventional system, only companies who hold UCC/EAN numbers can sponsor coupons using the existing UCC/EAN-128 coupon formats. With the coupon redemption system described herein, the system is opened up to any company, person or other entity that has a credit or debit card account and a personal computer with bar code printing software, regardless of whether or not they are a manufacturer in the UPC system. New commercial opportunities are expected to result.

To create a system whereby the coupons can optimally be used and redeemed via a credit or debit card transaction system, several technologies and business practices should be put in place, including:

a. Bank Partnering—Banks must be setup to process coupon issuer's credit or debit card accounts in contractual arrangements with escrow accounts and minimum balances.

b. Processing/Scanners Use—“Verifone” or other credit card processing machines which can accept the coupon information from coupons. Use bar code scanners that can read RSS coupons and traditional coupons and talk to the credit card processing machine.

c. Retailer Acceptance—Retailers must be willing to change internal software to read and understand RSS coupon information, upgrade checkout scanners to read RSS coupons, or double scan coupons with both their traditional system and the newly installed 2-D Verifone/scanners and telephone line, and give up their current redemption processor.

d. Manufacturer Acceptance—Manufacturers must be willing to print coupons with the additional RSS information included in them, e.g., using software from Barcode Technology.

e. Customer Acceptance—Customers must be willing to use RSS coupons. This should not be a problem since the bar code type is of little concern to consumers. The product and discount are of most concern.

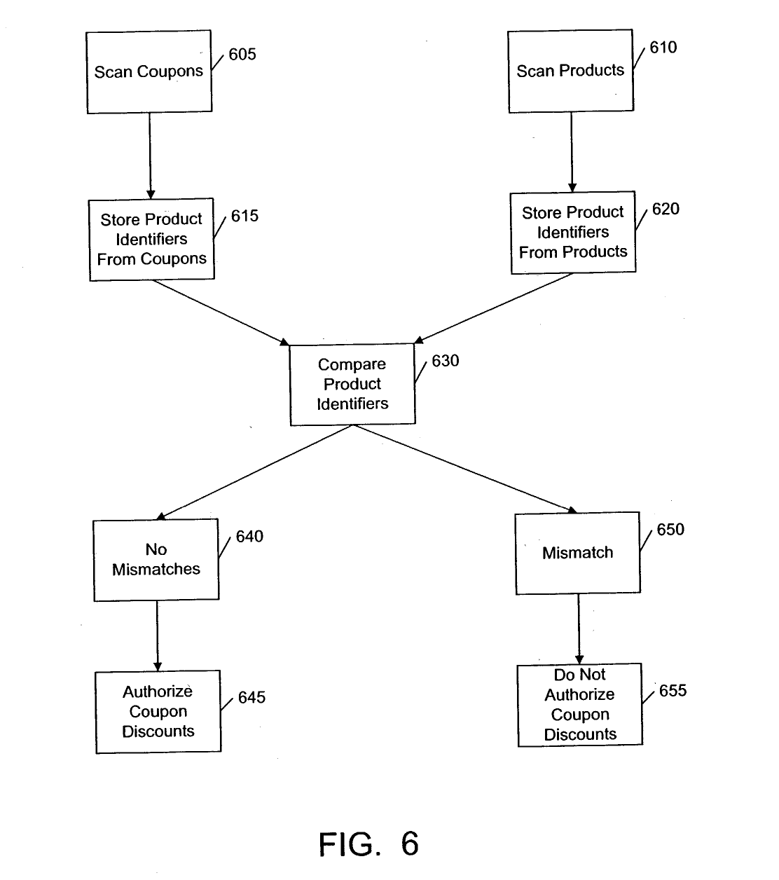

FIG. 6 illustrates a method for ensuring that coupons are redeemed only when the associated product has been purchased.

One problem of traditional coupon processing is that the merchant's computer system is not aware of new coupons as they are issued. This makes it difficult for the merchant's computer system to know what to do with, or how to handle, new coupon offers. For example, a security method that insures that the associated products for a given coupon are actually present in the customer order requires that the computer system know which products and product families are to be associated with the offer. If that information were known, then the scanner and computer could double check to see that the UPC (A) code exists for the products and coupons associated with the products being purchased. To solve the problem, the RSS coupon itself could contain the associated product identifier, such as the Global Trade Item Number (GTIN) information. The GTIN is a 14-digit number that provides more specific information than the 12-digit UPC code in the form of a packaging designator. For example, the UPC code might identify a product such as soap, while the GTIN also indicates whether the soap is packaged as a single item, six-pack, or carton. The computer could read the coupon and the associated product GTIN and examine the other products in the transaction for the presence of that GTIN or UPC (A) code. If there is a match, coupon redemption is authorized. The UPC-A Bar Code Symbol is a bar code symbol of the EAN/UPC Symbology that encodes UCC-12 Identification Numbers. See FIG. 4(b). GTINs could be available on all RSS bar coded coupons. If we had to emulate the older style UCC/EAN-128 Coupon Formats, we would put the 2-D portion of the coupon above the UPC left half or EAN-128 right half of an existing bar code symbol type. In those cases there would be no GTIN present.

The above process is illustrated in FIG. 6. At block 605, the coupons that are provided in accordance with the invention are scanned in at the POS. The products that are being purchased are also scanned (block 610). These steps may occur in any order. At block 615, product identifiers that are provided in the coupons are temporarily stored, and at block 620, the product identifiers from the bar codes on the products are also stored. These product identifiers may be GTIN codes. At block 630, which may be performed when the consumer's order is totaled, a determination is made as to whether any of the product identifiers from the coupons do not have a match with a product identifier from the products that are being purchased. If there is no mismatch (block 640), the coupon discounts are authorized (block 645). If there is a mismatch (block 650), the coupon discounts are not authorized. Moreover, a message may be generated, e.g., on the cash register and-display, to inform the cashier and consumer of the specific coupon that has not been authorized. Advantageously, unauthorized and fraudulent coupon redemptions can be curtailed.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A bar-coded coupon suitable for redemption at a point of sale location, comprising:
a bar code symbol carrying an account identifier of an issuer of the coupon, a product or service identifier, and an identifier of a discount amount to be credited to a consumer upon purchase of the product or service, and to be charged to the issuer in accordance with the account identifier.

2. The bar-coded coupon of claim 1, wherein:
the account identifier comprises at least one of a credit card number and debit card number.

3. The bar-coded coupon of claim 1, further comprising:
a substrate on which the bar code symbol is printed.

4. The bar-coded coupon of claim 1, wherein:
at least a portion of the bar code symbol comprises a two-dimensional symbol in which the account identifier is carried.

5. The bar-coded coupon of claim 4, wherein:
the two-dimensional symbol comprises a Reduced Space Symbology (RSS) symbol.

6. The bar-coded coupon of claim 1, wherein:
the bar code symbol includes a one-dimensional portion carrying first coupon information, and a two-dimensional portion carrying the account identifier.

7. The bar-coded coupon of claim 1, wherein:
the product or service identifier comprises a Global Trade Item Number (GTIN) for use in authorizing redemption of the coupon at the point of sale location.

8. A bar-coded coupon suitable for redemption at a point of sale location, comprising:
a bar code symbol carrying an identifier of an account of an issuer of the coupon, an identifier of a consumer's account, and an identifier of an award amount to be awarded to the consumer's account and to be charged to the issuer's account.

9. The bar-coded coupon of claim 8, wherein:
the coupon is printed by the consumer as a web-based coupon; and
the bar code symbol carries information associated with the consumer obtained during interaction of the consumer with the web site.

10. The bar-coded coupon of claim 8, wherein:
the award amount is designated by the web site.

11. The bar-coded coupon of claim 8, wherein:
the issuer's account identifier comprises at least one of a credit card number and a debit card number.

12. The bar-coded coupon of claim 8, wherein:
at least a portion of the bar code symbol comprises a two-dimensional symbol in which the issuer's account identifier is carried.

13. A coupon card suitable for redemption at a point of sale location, comprising:
at least one of a magnetic strip card and a smart cart carrying an identifier of an account of an issuer of the coupon, an identifier of a consumer's account, and an identifier of an award amount to be awarded to the consumer's account and to be charged to the issuer's account.

14. A method for processing a bar-coded coupon at a point of sale location, comprising:
scanning a bar code symbol on the coupon to obtain an account identifier of an issuer of the coupon, a product or service identifier, and an identifier of a discount amount to be credited to a consumer upon purchase of the product or service, and to be charged to the issuer in accordance with the account identifier.

15. The method of claim 14, further comprising:
communicating the account identifier, product or service identifier, and discount amount identifier to a processing center for processing thereat.

16. The method of claim 15, wherein:
said communicating is performed using a credit card terminal at the point of sale location.

17. The method of claim 14, wherein:
the account identifier comprises a credit card number, and the account identifier, product or service identifier, and discount amount identifier are communicated to the processing center using a credit card communication protocol.

18. The method of claim 14, wherein:
the account identifier comprises a debit card number, and the account identifier, product or service identifier, and discount amount identifier are communicated to the processing center using a debit card communication protocol.

19. The method of claim 14, wherein:
at least a portion of the bar code symbol comprises a two-dimensional symbol in which the account identifier is carried.

20. The method of claim 19, wherein:
the two-dimensional symbol comprises a Reduced Space Symbology (RSS) symbol.

21. The method of claim 14, wherein:
the bar code symbol includes a one-dimensional portion carrying first coupon information, and a two-dimensional portion carrying the account identifier.

22. A method for processing a,coupon card at a point of sale location, comprising:
reading at least one of a magnetic strip card and a smart cart carrying an account identifier of an issuer of the coupon, a product or service identifier, and an identifier of a discount amount to be credited to a consumer upon purchase of the product or service, and to be charged to the issuer in accordance with the account identifier.

23. A method for processing coupon transaction information received from a merchant at a point of sale location, comprising:
recovering, from the coupon transaction information, an account identifier, of an issuer of the coupon, a discount amount identifier that has been credited to a consumer upon purchase of a product or service from the merchant, and an account identifier of the merchant;
providing a charge against the account of the issuer according to the discount amount identifier and the account identifier of the issuer; and
providing a payment on behalf of the merchant according to the discount amount identifier and the account identifier of the merchant.

24. The method of claim 23, further comprising:
recovering, from the coupon transaction information, an identifier of the product or service.

25. The method of claim 23, further comprising:
recovering, from the coupon transaction information, demographic data associated with the consumer.

26. The method of claim 23, wherein:
the issuer's account identifier comprises at least one of a credit card number and a debit card number.

27. The method of claim 23, wherein:
the coupon transaction information is received from a credit card terminal at the point of sale location.

28. A method for processing coupon transaction information received from a merchant at a point of sale location, comprising:
recovering, from the coupon transaction information, an account identifier of an issuer of the coupon, an identifier of an award amount to be awarded to a consumer, and an account identifier of the consumer;
providing a charge against the account of the issuer based in accordance with the award amount identifier and the issuer's account identifier; and
providing an award on behalf of the consumer in accordance with the award amount identifier and the consumer's account identifier.

29. The method of claim 28, wherein:
the issuer's account identifier comprises at least one of a credit card number and a debit card number.

30. The method of claim 28, wherein:
the consumer's account identifier comprises at least one of a credit card number, debit card number, and bank account number.

31. A method for authorizing redemption of a bar-coded coupon at a point of sale location, comprising:
(a) scanning the coupon to obtain at least one product identifier therefrom;
(b) scanning at least one product purchased by a consumer at the point of sale location to obtain at least one product identifier therefrom;
(c) comparing the at least one product identifier obtained in step (a) to the at least one product identifier obtained in step (b) to determine whether there is a mismatch; and
(d) if there is no mismatch, authorizing redemption of the coupon; and
(e) if there is a mismatch, not authorizing redemption of the coupon.

32. The method of claim 31, wherein:
the at least one product identifier obtained in step (a) comprises at least one of a Global Trade Item Number (GTIN) and a UPC bar code symbol.

33. The method of claim 31, wherein:
the at least one product identifier obtained in step (b) comprises at least one of a Global Trade Item Number (GTIN) and a UPC bar code symbol.

34. A computer program product for use in printing a bar-coded coupon suitable for redemption at a point of sale location, comprising:
software adapted to be executed by a computer for use in printing a bar code symbol carrying an account identifier of an issuer of the coupon, a product or service identifier, and an identifier of a discount amount to be credited to a consumer upon purchase of the product or service, and to be charged to the issuer in accordance with the account identifier.

35. The computer program product of claim 34, wherein:
the account identifier comprises at least one of a credit card number and debit card number.

36. The computer program product of claim 34, wherein:
at least a portion of the bar code symbol comprises a two-dimensional symbol in which the account identifier is carried.

37. The computer program product of claim 36, wherein:
the two-dimensional symbol comprises a Reduced Space Symbology (RSS) symbol.

38. The computer program product of claim 34, wherein:
the bar code symbol includes a one-dimensional portion carrying first coupon information, and a two-dimensional portion carrying the account identifier.

39. The computer program product of claim 34, wherein:
the product or service identifier comprises a Global Trade Item Number (GTIN) for use in authorizing redemption of the coupon at the point of sale location.

40. A computer program product for use in printing a bar-coded coupon suitable for redemption at a point of sale location, comprising:
software adapted to be executed by a computer for use in printing a bar code symbol carrying an identifier of an account of an issuer of the coupon, an identifier of a consumer's account, and an identifier of an award amount to be awarded to the consumer's account and to be charged to the issuer's account.

41. The computer program product of claim 40, wherein:
the coupon is printed by the consumer as a web-based coupon; and
the bar code symbol carries information associated with the consumer obtained during interaction of the consumer with the web site.

42. The computer program product of claim 40, wherein:
the award amount is designated by the web site.

43. The computer program product of claim 40, wherein:
the issuer's account identifier comprises at least one of a credit card number and a debit card number.

44. The computer program product of claim 40, wherein:
the consumer's account identifier comprises at least one of a credit card number, debit card number, and bank account number.

45. The computer program product of claim 40, wherein:
at least a portion of the bar code symbol comprises a two-dimensional symbol in which the issuer's account identifier is carried.

46. A bar-coded coupon suitable for redemption at a point of sale location, comprising:
a bar code symbol carrying an account identifier of an issuer of the coupon, a product or service identifier, and an identifier of a discount amount to be credited to a consumer upon purchase of the product or service, and to be charged to the issuer in accordance with the account identifier; wherein:
the account identifier comprises at least one of a credit card number and debit card number.

47. A method for processing a bar-coded coupon at a point of sale location, comprising:
scanning a bar code symbol on the coupon to obtain an account identifier of an issuer of the coupon, a product or service identifier, and an identifier of a discount amount to be credited to a consumer upon purchase of the product or service, and to be charged to the issuer in accordance with the account identifier; wherein:
the account identifier comprises at least one of a credit card number and debit card number.

48. A method for processing coupon transaction information received from a merchant at a point of sale location, comprising:
recovering, from the coupon transaction information, an account identifier of an issuer of the coupon, a discount amount identifier that has been credited to a consumer upon purchase of a product or service from the merchant, and an account identifier of the merchant;
providing a charge against the account of the issuer according to the discount amount identifier and the account identifier of the issuer; and
providing a payment on behalf of the merchant according to the discount amount identifier and the account identifier of the merchant; wherein:
the issuer's account identifier comprises at least one of a credit card number and a debit card number.
